(19) United States
(12) Patent Application Publication
(10) Pub. No.: US 2012/0108798 A1
(43) Pub. Date: May 3, 2012

(54) Production Of Pure Lignin From Lignocellulosic Biomass

(75) Inventors: Kevin S. Wenger, Hanover, NH (US); David A. Hogsett, Grantham, NH (US); Michael Ladisch, West Lafayette, IN (US); John Basdsley, Newport, NH (US)

(73) Assignee: Mascoma Corporation, Lebanon ,, NH (US)

(21) Appl. No.: 13/124,255

(22) PCT Filed: Oct. 16, 2009
(86) PCT No.: PCT/US2009/061040

§ 371 Date: Oct. 17, 2011

Related U.S. Application Data
(60) Provisional application No. 61/136,956, filed on Oct. 17, 2008.

(51) Int. Cl. C08H 7/00; C12S 3/00

(52) U.S. Cl. 530/500; 435/267

(57) ABSTRACT

The present invention is directed to a process of producing substantially pure lignin from lignocellulosic biomass, which comprises: pre-treating a lignocellulosic feedstock to produce a reactive lignin-carbohydrate mixture; biologically-reacting the carbohydrates in the mixture, separating remaining solids from the liquid fermentation products, and drying the resulting solids to yield a substantially pure lignin product. Optionally, the lignin product may be washed and subjected to a second hydrolysis step. Optionally, the lignin product may be further processed by hydrotreating and/or pyrolysis in order to yield desirable products such as fuel additives.

### BACKGROUND OF THE INVENTION

1. Field of the Invention

The present invention is directed to processes for producing substantially pure lignin from lignocellulosic biomass. In some aspects, the lignin produced by methods of the invention is free of harsh chemicals. The lignin produced in this manner is useful for further processing into fuel additives.

2. Background Art

Plant biomass and derivatives thereof are a natural resource for the biological conversion of energy to forms useful to humanity. Among forms of plant biomass, lignocellulosic biomass is particularly well-suited for energy applications because of its large-scale availability, low cost, and environmentally benign production. In particular, many energy production and utilization cycles based on lignocellulosic biomass have near-zero greenhouse gas emissions on a life-cycle basis.

Plant biomass can be classified in three main categories: sugar, starch and cellulose containing plants. Cellulose-containing plants and waste products are the most abundant forms of biomass; these materials are referred to as lignocellulosic biomass because they contain cellulose (20% to 60%), hemicellulose (10% to 40%) and lignin (5% to 25%) while non-woody biomass generally contains less than about 15-20% lignin.

Lignocellulosic biomass is composed of cellulose, hemicellulose and lignin, with smaller amounts of proteins, lipids (fats, waxes and oils) and ash. Roughly, two-thirds of the dry mass of cellulosic materials are present as cellulose and hemicellulose. Lignin makes up the bulk of the remaining dry mass.

Lignin or lignen is a complex chemical compound most commonly derived from wood and an integral part of the cell walls of plants. The term was introduced in 1819 by de Candolle and is derived from the Latin word lignum, meaning wood. It is one of the most abundant organic polymers on Earth, superseded only by cellulose, employing 30% of non-fossil organic carbon and constituting from a quarter to a third of the dry mass of wood. The compound has several unusual properties as a biopolymer, not least its heterogeneity in lacking a defined primary structure.

Lignin fills the spaces in the cell wall between cellulose, hemicellulose and pectin components, especially in tracheids, sclereids and xylem. It is covalently linked to hemicellulose and thereby crosslinks different plant polysaccharides, conferring mechanical strength to the cell wall and by extension the plant as a whole. It is particularly abundant in compression wood.

In sulfite pulping, lignin is removed from wood pulp as sulfonates. These lignosulfonates have several uses as dispersants in high performance cement applications, water treatment formulations and textile dyes, additives in specialty oil field applications and agricultural chemicals, raw materials for several chemicals, such as vanillin, DMSO, ethanol, torula yeast, xylitol sugar and humic acid, and as an environmentally sustainable dust suppression agent for roads. However the high sulfur content of lignosulfonates prevent the use of lignin in other applications, most notably as fuel additives, for example in gasoline or diesel fuel.

Other delignification technologies use organic solvents or a high pressure steam treatment combined with a strong acid or strong base to remove lignin from plants. These delignification technologies are subject to the disadvantages of large chemical costs, the expensive disposal of environmentally hazardous waste products, and the production of unwanted side products from the delignification steps.

U.S. Pat. No. 5,730,837 discloses a method of separating lignin based on the use of alcohol, water, and a water immiscible ketone.

U.S. Pat. No. 5,047,332 discloses a biological method of recovering lignin using fermentation of pretreated lignocellulosic materials with aerobic cellulolytic fungi.

U.S. Pat. No. 5,735,916 discloses a method of recovering lignin as part of a biological conversion process, where the lignin recovery is made by caustic hydroxide solution.

U.S. Pat. No. 6,172,272 discloses a method of converting isolated lignin into reformatted, partially oxygenated gasoline.

The present invention is concerned with the generation of substantially pure lignin from lignocellulosic material without the need for harsh chemical additives or organic solvents. In some embodiments, the present invention combines a steam pretreatment without the use of harsh chemicals, with a biological cellulose degradation step to yield substantially pure lignin. In some embodiments, the particular combination of pretreatment and biological converting results in a high purity lignin product.

### BRIEF SUMMARY OF THE INVENTION

The present invention is directed to a process of producing substantially pure lignin from lignocellulosic biomass, which comprises: pre-treating a lignocellulosic feedstock to produce a reactive lignin-carbohydrate mixture; biologically-reacting the carbohydrates in the mixture, separating remaining solids from the liquid fermentation products, and drying the resulting solids to yield a substantially pure lignin product. Optionally, the lignin product may be further processed by hydrotreating and/or pyrolysis in order to yield desirable products such as fuel additives. The steps of biologically-reacting and separating can be repeated one or more times.

In certain embodiments, the present invention further comprises de-watering or drying the substantially pure lignin. In other embodiments, the present invention further comprises treating the substantially pure lignin by hydrogenation or pyrolysis.

In certain embodiments of the present invention, lignocellulosic biomass is selected from the group consisting of grass, switch grass, cord grass, rye grass, reed canary grass, miscanthus, sugar-processing residues, sugarcane bagasse, agricultural wastes, rice straw, rice hulls, barley straw, corn cobs, cereal straw, wheat straw, canola straw, oat straw, oat hulls, corn fiber, stover, soybean stover, corn stover, forestry wastes, recycled wood pulp fiber, paper sludge, sawdust, hardwood, softwood, and combinations thereof.

In certain embodiments, the present invention involves a lignocellulosic pre-treatment step wherein the pre-treating is selected from the group consisting of catalytic treatment, acid treatment, alkaline treatment, organic solvent treatment, steam treatment, heat treatment, low-pH treatment, pressure treatment, milling treatment, steam explosion treatment, pulping treatment or white rot fungi treatment and combinations thereof, in further embodiments the pre-treatment is a combination of steam treatment and heat treatment.

In some embodiments of the present invention, the biologically-reacting comprises enzymatically hydrolyzing cellulose and hemi-cellulose to form monomeric sugars. In certain embodiments, the biologically-reacting comprises hydrolyzing cellulose and hemi-cellulose to form monomeric sugars. In certain embodiments of the invention, the converting comprises hydrolyzing cellulose and hemi-cellulose to form monomeric sugars, and fermenting said monomeric sugars to produce ethanol.

In certain embodiments of the present invention, the fermenting comprises enzymatically fermenting said monomeric sugars to produce ethanol. In certain embodiments, the hydrolyzing and fermenting occur concurrently in the same reactor and in certain embodiments of the present invention hydrolyzing and fermenting are carried out separately.

In some embodiments, the substantially pure lignin is produced after the carbohydrate component of the lignocellulosic material is converted to monomeric sugars and the monomeric sugars are biologically converted to products which are then removed, leaving substantially pure lignin.

In some embodiments, after fermentation the substantially pure lignin is optionally treated with high temperature liquid water, and/or optionally treated with additional cellulases to improve lignin purity.

In certain embodiments, the substantially pure lignin is further treated, for example, through pyrolysis and/or hydrotreating.

Another embodiment of the invention is directed to lignin produced by the above-mentioned processes.

### BRIEF DESCRIPTION OF THE DRAWINGS/FIGURES

FIG. 1 depicts a process for hydrotreating lignin derived from the pretreatment and hydrolysis of biomass.

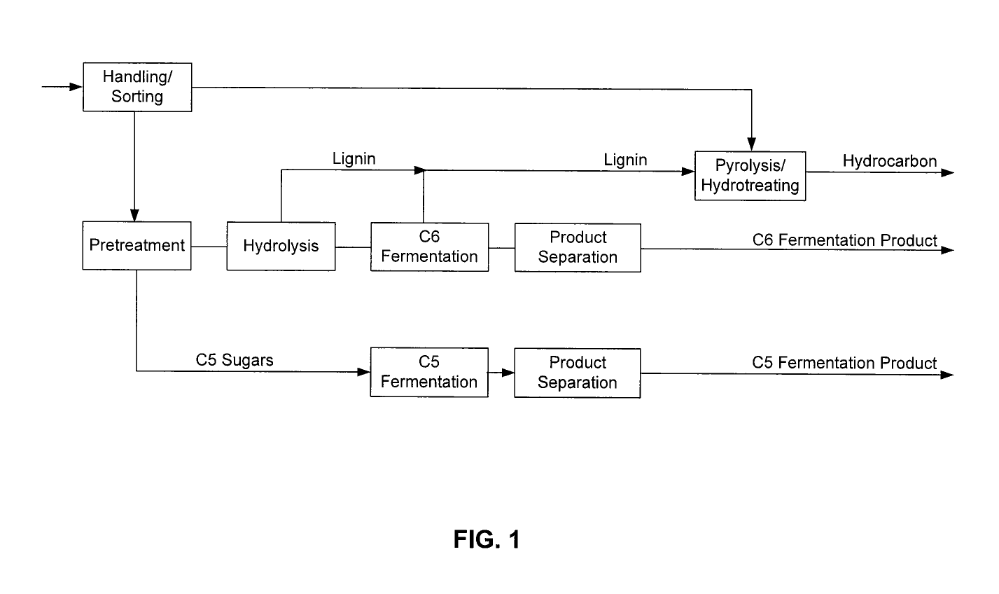

FIG. 2 depicts a process for converting biomass to fermentable products with a pyrolysis/hydrotreating unit.

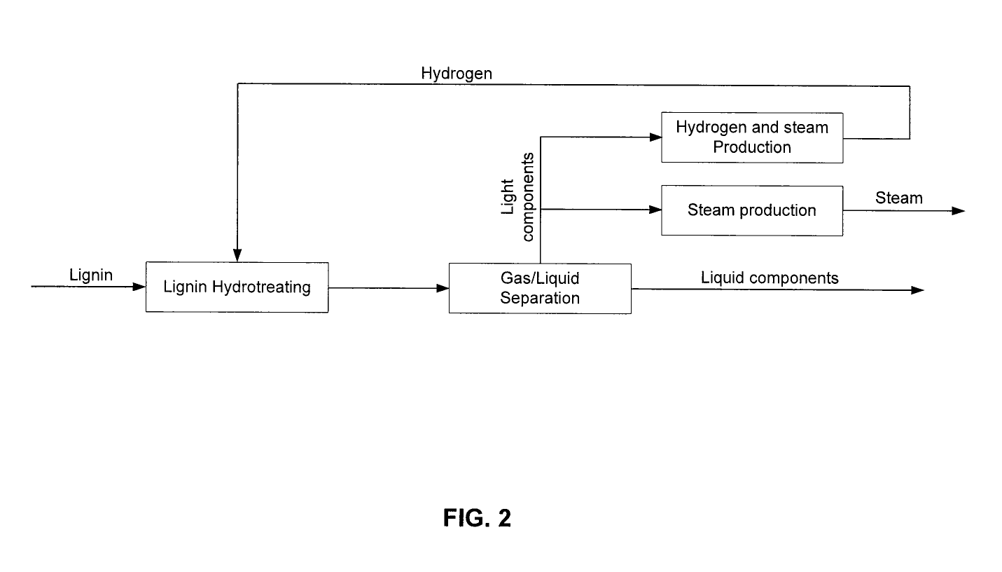

FIG. 3 depicts a process of pyrolyzing lignin derived from the pretreatment and hydrolysis of biomass.

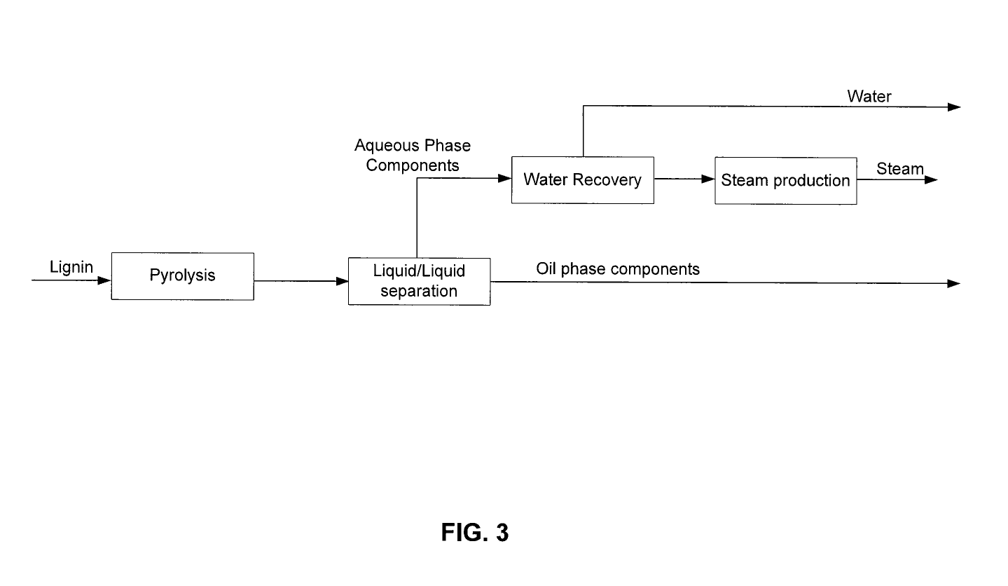

FIG. 4 depicts a process for pyrolyzing of lignin derived from the pretreatment and hydrolysis of biomass followed by subsequent hydrotreating of the resulting oily fraction.

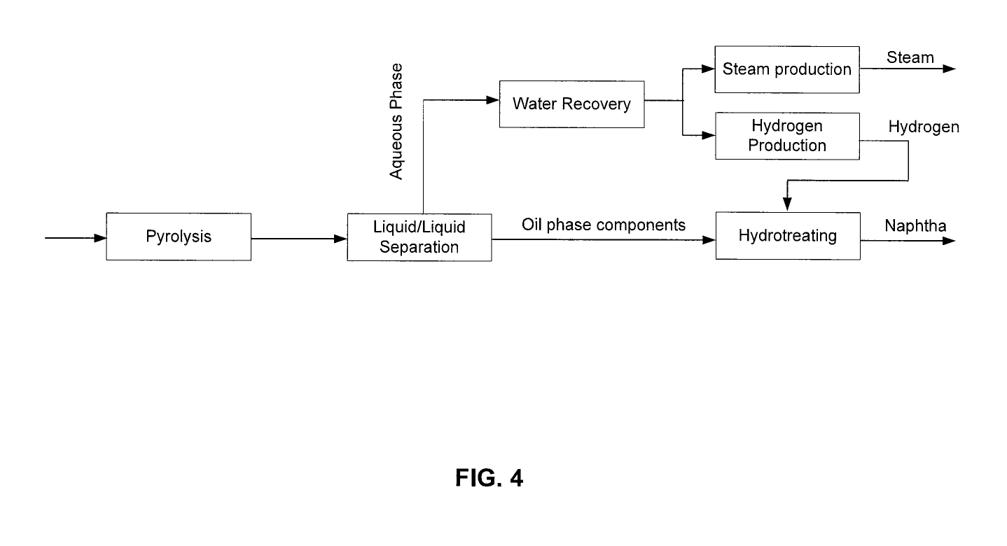

### DETAILED DESCRIPTION OF THE INVENTION

In some embodiments, the present invention is directed to a process of producing substantially pure lignin from lignocellulosic biomass, which includes steam pretreating a lignocellulosic material at a pH between about 5 and about 8; biologically converting the pretreated lignocellulosic material to yield one or more soluble products and lignin; and, separating the one or more soluble products from said lignin to yield substantially pure lignin. In some embodiments, the biologically converting and separating steps can be repeated one or mor times to further improve purity.

The substantially pure lignin produced by the present invention refers to lignin that is at least 50%, at least 60%, at least 70%, at least 80%, or at least 90%, or at least 95% pure lignin. Trace impurities such as ash, carbohydrate, and sulfur are minimized and comprise only a minority of the substantially pure lignin. In some embodiments, carbohydrates comprise less than 30% less than 20%, less than 11%, less than 10%, less than 7%, less than 6%, less than 5%, less than 4%, less than 3%, less than 2%, or less than 1% of the final substantially pure lignin product. In some embodiments, ash comprises less than 2%, less than 1%, less than 0.4%, or less that 0.2%, or less than 0.1%, or less than 0.05% of the final substantially pure lignin product. In some embodiments, the sulfur content in the substantially pure lignin product is less than 0.5%, less than 0.25%, less than 0.2%, less than 0.1%, and less than 0.05% sulfur. In certain embodiments, the lignin contains less than 0.5% ash, less than 5% carbohydrate, and less than 0.1% sulfur.

The terms “hemicellulose,” “hemicellulosic portions,” and “hemicellulosic fractions” mean the non-lignin, non-cellulose elements of lignocellulosic material, such as but not limited to hemicellulose (comprising xyloglucan, xylan, glucuronoxylan, arabinoxylan, mannan, glucomannan, and galactoglucomannan, inter alia), pectins (e.g., homogalacturonans, rhamnogalacturonan I and II, and xylogalacturonan), and proteoglycans (e.g., arabinogalactan-protein, extensin, and proline-rich proteins).

In certain embodiments lignocellulosic biomass can include, but is not limited to, woody biomass, such as recycled wood pulp fiber, sawdust, hardwood, softwood, and combinations thereof; grasses, such as switch grass, cord grass, rye grass, reed canary grass, miscanthus, or a combination thereof; sugar-processing residues, such as but not limited to sugar cane bagasse; agricultural wastes, such as but not limited to rice straw, rice hulls, barley straw, corn cobs, cereal straw, wheat straw, canola straw, oat straw, oat hulls, and corn fiber; stover, such as but not limited to soybean stover, corn stover; and forestry wastes, such as but not limited to recycled wood pulp fiber, sawdust, hardwood (e.g., poplar, oak, maple, birch), softwood, or any combination thereof.

Paper sludge is also a viable feedstock for lignin production. Paper sludge is solid residue arising from pulping and paper-making, and is typically removed from process wastewater in a primary clarifier. The size range of the substrate material varies widely and depends upon the type of substrate material used as well as the requirements and needs of a given process. In certain embodiments of the invention, the lignocellulosic biomass may be prepared in such a way as to permit ease of handling in conveyors, hoppers and the like. In the case of wood, the chips obtained from commercial chippers are suitable; in the case of straw it is sometimes desirable to chop the stalks into uniform pieces about 1 to about 3 inches in length. Depending on the intended degree of pretreatment, the size of the substrate particles prior to pretreatment may range from less than a millimeter to inches in length.

Cellulose molecules are linear and unbranched and have a strong tendency to form inter- and intra-molecular hydrogen bonds. Bundles of cellulose molecules are thus aggregated together to form microfibrils in which highly ordered (crystalline) regions alternate with less ordered (amorphous) regions. Microfibrils make fibrils and finally cellulose fibers. As a consequence of its fibrous structure and strong hydrogen bonds, cellulose has a very high tensile strength and is insoluble in most solvents.

Lignocellulosic biomass must therefore undergo pre-treatment to enhance susceptibility of the carbohydrate chains to hydrolysis which produces substantially pure lignin. The degradation of lignocellulosics is primarily governed by its structural features because cellulose possesses a highly ordered structure and the lignin surrounding cellulose forms a physical barrier.

Pretreatment is required to reduce the order of the cellulose and increases surface area. Pretreatment methods can be physical, chemical, physicochemical and biological, depending on the mode of action. The various pretreatment methods that have been used to increase cellulose digestibility include ball-milling treatment, two-roll milling treatment, hammer milling treatment, colloid milling treatment, high pressure treatment, radiation treatment, pyrolysis, catalytic treatment, acid treatment, alkaline treatment, organic solvent treatment, steam treatment, heat treatment, low-pH treatment, steam explosion treatment, pulping treatment, white rot fungi treatment, and ammonia fiber explosion and combinations thereof. A further discussion of pretreatments can be found in Holtzapple et al. (U.S. Pat. No. 5,865,898; hereby incorporated by reference). Exposure time, temperature, and pH are the additional metrics that govern the extent to which the cellulosic carbohydrate fractions are cleaved during pre-treatment and amenable to further enzymatic hydrolysis in subsequent biological conversion steps.

Steam-explosion has been identified as a low cost and high yield technology, along with low-pressure steam autohydrolysis. Steam explosion heats wetted lignocellulose to high temperatures (e.g., about 160° C. to about 230° C.) and releases the pressure immediately. Rapid decompression flashes the water trapped in the fibers, which leads to a physical size reduction of the fibers. The elevated temperatures remove acetic acid from hemicellulose which allows some autohydrolysis of the biomass. In certain embodiments, additional chemical agents, such as sulfuric acid or ammonia (e.g., gaseous, anhydrous liquid, or ammonium hydroxide), may be added to aid in the hydrolysis. In certain embodiments, the pretreated cellulose can then be sterilized to prevent growth of other microorganisms during the fermentation reaction. In some embodiments, no harsh chemical treatments are added to the lignocellulosic biomass. Alternatively, the pH of the biomass may be adjusted by the addition of a base or an acid. In some embodiments, the pH of the lignocellulosic material is maintained at between about 5 to about 8. In other embodiments, the pH of the lignocellulosic material is maintained at between about 6 to about 8.

In certain further embodiments the pre-treatment is a combination of steam treatment and heat treatment. In certain embodiments of the steam treatment and hydrolysis, lignocellulosic biomass is subjected to steam pressure of between 100 psig and 700 psig. A vacuum may be pulled within the reactor to remove air, for example, at a pressure of about 50 to about 300 mbar. The lignocellulosic biomass can be pre-wetted to a moisture content of between about 60% to about 80%. In some embodiments the moisture content is about 65% to about 75%. Steam may be added to the reactor containing the lignocellulosic material at a saturated steam pressure of between about 100 psig and about 700 psig. In some embodiments, a saturated steam pressure from about 140 psig to about 300 psig can be used. The temperature of the heat treatment can be about 165° C. to about 220° C. In some embodiments, the temperature can be about 175° C. to about 210° C., or about 180° C. to about 220° C.

The steam pretreatment of the present invention can be either batch or continuous pretreatment. In continuous pretreatment, wetted feedstock is compressed by means of a rotating screw which feeds the material into the high pressure reactor. The compression of the incoming material serves to maintain the pressure in the pretreatment reactor. The material is thereafter conveyed through the pretreatment reactor by means of a rotating screw. Adjustment of the residence time is made by controlling the material feed rate through the reactor. During the depressurization, it may be advantageous to further reduce the size of the biomass through the use of a mechanical refiner. A “refiner” may mean an apparatus capable of reducing a particle in size. One can refine lignocellulosic material as described herein using commercially available refiners. For example, disc refiners made by Metso and Andritz as may be appropriate for this purpose. Such apparatus may include single or multiple rotating disks, or be of another design, and may operate either under a set pressure or at atmospheric pressure. A refiner may be a plate grinder, a wood grinder, or a disintegrator. Disintegrators manufactured by Hosokawa may be used to refine pretreated lignocellulosic material.

During such steam pretreatment, acids present in the feedstock may raise the pH of the system such that undesirable sugar byproducts are produced. In some embodiments of the present invention, a base may be added to reduce the pH of the system. In some embodiments the base maintains the pH of the system in a range of about 4 to about 9, or from about 5 to about 8, or from about 6 to about 7.

In certain embodiments of the present invention, steam pretreatment produces a lignocellulosic feedstock which is substantially free of chemical additives such as sulfur compounds, mineral spirits, harsh bases, harsh acids and the like. The use of these additives can prevent the optimal action of subsequent biological lignin purification processes and can lead to trace impurities in the eventual lignin product. These impurities in turn can lower the utility of the lignin for subsequent use, for example in further processing as a fuel additive.

After pretreatment, the resultant carbohydrate mixture can be further converted to monosaccharides using biological conversion by either enzyme hydrolysis and/or microbes. Previous inventions have employed acid hydrolysis, which although simple, produces many undesirable degradation products. Enzymatic hydrolysis, however, by such enzymes as cellulases, endoglucanases, exoglucanases, cellobiohydrolases, β-glucosidases, xylanases, endoxylanases, exoxylanases, β-xylosidases, arabinoxylanases, mannases, galactases, pectinases, glucuronidases, amylases, α-amylases, β-amylases, glucoamylases, α-glucosidases, isoamylases provide the cleanest in that it is less likely to produce byproducts detrimental to subsequent lignin processing steps. Such saccharification enzymes which perform hydrolysis may be produced synthetically, semi-synthetically, or biologically including using recombinant microorganisms.

In certain embodiments, a recombinant organism is selected from the group consisting of Escherichia coli, Zymomonas mobilis, Bacillus stearothermophilus, Saccharomyces cerevisiae, Clostridium thermocellum, Kluyveromyces marxianus Thermoanaerobacterium saccharolyticum, Pichia stipitis, Escherichia, Zymomonas, Saccharomyces, Candida, Pichia, Streptomyces, Bacillus, Lactobacillus, and Clostridium. In certain embodiments the recombinant organism may perform hydrolysis and fermentation concurrently, also known in the art as simultaneous saccharification and co-fermentation (SSF of SSCF). In certain embodiments of the present invention, fermentation organisms can be selected from bacteria, fungi, yeast or a combination thereof.

In some embodiments of the present invention, microorganisms of the invention are genetically modified to express cellulase enzymes to facilitate the removal of cellulose from the lignocellulosic material. Suitable cellulases include endoglucanases, cellobiohydrolases, and β-glucosidases. Alternatively, in some embodiments exogenous cellulases can be added to the fermentation mixture in order to facilitate cellulose and hemicellulose hydrolysis. Suitable enzymes for the process of the invention, include without limitation, those listed above. The skilled artisan will readily determine which combination of enzymes are most useful for processes of the invention based on the type of feedstock to be used.

The present invention provides for the heterologous expression of cbh1 and/or cbh2 polynucleotide sequences. In some embodiments, the cbh1 and/or cbh2 is from Talaromyces emersonii (T. emersonii), Humicola grisea (H. grisea), Thermoascus aurantiacus (T. aurantiacus), and Trichoderma reesei (T. reesei). The present invention also provides for the heterologous expression of an endoglucanase. In some embodiments, the endoglucanase is from T. reesei. In some embodiments, the present invention provides for the expression of a β-glucosidase. The β-glucosidase can be any suitable β-glucosidase. In some embodiments the β-glucosidase is from S. fibuligera.

In some embodiments, genes encoding exogenous enzymes expressed by organisms of the invention are codon-optimized for expression in the host organism.

It is well appreciated in the art, that the lignin component of lignocellulosic material adsorbs cellulase enzymes and thus sequesters them away from cellulose, leading to reduced enzyme activity. In some embodiments of the present invention, inexpensive proteins or peptides may be used in order to block non-specific cellulase adherent sites of the lignin. Suitable proteins include soy protein, proteins from fish processing waste, spoiled or expired food stock, algal protein, albumin, whey protein, grain processing waste, sugar processing waste, or any suitable, inexpensive protein.

In some embodiments of the invention, two or more microorganisms of the invention may be co-cultured. “Co-culture” consists of allowing at least two different strains or species of microorganisms to grow in the same reaction vessel or on the same substrate in different reaction vessels in fluid communication with each other. The different organisms may digest different components of the lignocellulosic material, or may act additively, or synergistically to digest the cellulose and hemicellulose components of the feedstock. In some aspects of the invention, the co-cultured organisms are Clostridium and Thermoanerobacterium. In some aspects, the co-cultured organisms are Clostridium thermocellum and Thermoanerobacterium saccharolyticum. Alternatively, two or more microorganisms may be cultured in a series, by growing a primary microorganism, optionally followed by removal of the primary microorganism, and then by growing one or more additional organisms on the substrate.

In certain embodiments of the present invention, lignocellulosic pre-treatments occur at higher temperature, longer residence time, and lower pH to initiate a greater extent of hydrolysis, which typically reduces the additional enzyme loading required to liberate soluble monomers that can be metabolized by the organisms responsible for ethanol production. However, mild pre-treatments typically outputs more carbohydrate oligomers, therefore requiring higher enzyme loading to liberate soluble monomers suitable for conversion.

“Fermentation” or “fermentation process” refers to any process comprising a fermentation step. A fermentation process of the invention includes, without limitation, fermentation processes used to produce alcohols, organic acids, ketones, amino acids, gases, antibiotics, enzymes, vitamins and hormones. Fermentation processes also include fermentation processes used in the consumable alcohol industry, dairy industry, leather industry and tobacco industry. The product of the fermentation process is referred to herein as beer.

In certain embodiments, the carbohydrate components of the lignocellulosic material is further converted to beer via a fermentation step, which yields ethanol and non-fermented solids, which are both recovered. Therefore in certain embodiments of the present invention, converting is chemically converting or biologically converting a reactive lignocellulosic mixture to form a beer. In certain embodiments chemical conversion comprises acid hydrolysis, alkali hydrolysis, organic solvent treatment or combinations thereof. In certain embodiments biologically converting the reactive carbohydrate mixture to form a beer comprises the addition of bacteria, fungi, yeast or a combination thereof

In some embodiments, post fermentation, the substantially pure lignin remains as a solid which can be separated from the liquid phase by centrifugation, filtration, or using a distillation column operated as a beer stripper as described for example in U.S. Pat. No. 7,297,236. A suitable beer stripper could be purchased from ICM, Inc., Colwich, Kans., Delta-T, Inc., Williamsburg, Va., or Fagan, Inc., Granite Falls, Minn.

Certain embodiments of the present invention further comprise de-watering, drying directly or indirectly, and harvesting the substantially pure lignin. De-watering (or drying) of the substantially pure lignin is useful in some embodiments because moisture may decrease the efficiency of subsequent reactions of the present invention. Separating the solids from the beer prior to ethanol recovery may involve dewatering in a screw press, which is followed by drying. However, the presence of alcohol during solids separation can complicate the drying process, requiring costly and complex closed-loop dryers and with a vapor recovery system. U.S. Pat. No. 4,952,504 (incorporated by reference) discloses that equipment, such as a screen centrifuge or screw press, can be used to de-water solids after fermentation.

In certain embodiments, the heat source used during ethanol stripping and de-watering is direct. In another embodiment, the heat source is indirect. Heat sources include but are not limited to direct steam, direct superheated steam, and indirect steam.

In certain embodiments involving indirect heat sources, the beer can be fed to a paddle dryer apparatus. The agitation provided by the paddle assembly dis-aggregates the beer and conveys it through the vessel as a thin layer of solids in a helical flow path along a jacketed wall. This enhances mass transfer of volatile materials, ideal for removing tightly entrapped volatiles in materials with fine particle size or poor flowability. The paddles minimize the build-up of solids in order to maintain a high heat transfer rate. These factors combined result in high heat transfer coefficients. This configuration is advantageous because it avoids the risks of plugging or fouling present in the traditional beer column tray and re-boiler design.

In certain embodiments involving direct heat sources, beer is fed to a dryer to which steam or super-heated steam is added. This dryer can be a vessel with positive motion provided by an augur or paddle, or it may be a more complex closed-loop drying system. In the former case, the configuration is as outlined for indirect heating. The beer is fed to a paddle dryer apparatus in which mixing and dis-aggregation is enabled by a paddle assembly; ethanol-water vapor stream is bled from the apparatus. In the latter case, superheated steam dryers are used to deliver heat to the solids and the moisture content to be evaporated. Heat from the superheated steam is transferred to the cooler product as it passes through a duct sized for a particular exposure time. This heat vaporizes a portion of the moisture in the solids, and a bleed stream is constantly drawn from the loop to maintain pressure. The water and ethanol vapor in this bleed stream are discharged from the vessel and passed to a distillation column where ethanol and water are separated without the presence of insoluble solids. This configuration is advantageous because it efficiently dries the solids and allows for vapor recovery of the ethanol.

In some further embodiments involving indirect heat sources, feed material is either pumped or conveyed into a paddle dryer apparatus. The agitation provided by the paddle assembly de-lumps and conveys the product material through the vessel as a thin-layer of solids in a helical flow-path along the jacketed wall, resulting in very high heat transfer coefficients. The paddles minimize the build-up of solids in order to maintain a high heat transfer rate and to mix and frequently to transport the solids. Drying is established from a heated surface in contact with the product. As the solids are spiraled along the inside vessel wall, heat is transferred by conduction. The water and ethanol vapor stream is discharged from the vessel and passed to a distillation column where ethanol and water are separated without the presence of insoluble solids.

In some embodiments, the insoluble solids are then removed by centrifugation. Suitable centrifuges include a clarifying decanter, decanter centrifuge, or continuous separator available from Westfalia Corporation or Alfa Laval Corporation.

In certain embodiments of the process, said converting comprises hydrolyzing cellulose and hemi-cellulose; to form monomeric sugars; and fermenting said monomeric sugars to produce ethanol and substantially pure lignin.

In some further embodiments of the present invention, hydrolyzing comprises enzymatically hydrolyzing cellulose and hemi-cellulose to form monomeric sugars.

In some further embodiments, said hydrolyzing comprises chemically hydrolyzing cellulose and hemi-cellulose to form monomeric sugars.

In other embodiments, hydrolysis and fermentation take place in separate vessels.

In some embodiments, after a biological fermentation or conversion, the lignin stream can be optionally washed with water and then optionally further treated with enzymes in order to hydrolyze remaining impurities such as sugars. Appropriate enzymes include, but are not limited to, cellulases, endoglucanases, exoglucanases, cellobiohydrolases, β-glucosidases, xylanases, endoxylanases, exoxylanases, β-xylosidases, arabinoxylanases, mannases, galactases, pectinases, glucuronidases, amylases, α-amylases, β-amylases, glucoamylases, α-glucosidases, isoamylases. The enzymes can be added exogenously. After such enzymatic treatment, the lignin can be dried and/or processed further.

In certain embodiments, said hydrolyzing and fermenting occur concurrently in the same reactor. In such cases, one or more aforementioned hydrolysis (saccharification) enzymes may be included in the solution containing one or more of the aforementioned fermentation organisms. In some embodiments, an additional hydrolysis step can be performed prior to the subsequent lignin processing.

In some embodiments, after lignin purification, the lignin-enriched stream is then sent to ether hydrotreating, a standard unit operation in refining, or to pyrolysis, a process that is well understood to and used to convert biomass into liquid and gaseous products. Non-limiting examples of methods for pyrolysis are described in U.S. Pat. No. 7,578,927 and U.S. Pat. No. 5,807,952. Non-limiting methods for hydrotreating lignin are described in U.S. Pat. No. 7,425,657, U.S. Pat. No. 4,420,644 and U.S. Pat. No. 6,172,272. In the case of pyrolysis, the resulting feedstock can be used either directly as a feedstock for a refinery or hydrotreated to remove sulfur and increase the degree of saturation. In some embodiments, the purified lignin is processed into fuel pellets.

In some embodiments, in the case of hydrotreating, the majority of the remaining cellulose and hemicellulose contained in the lignin-enriched feedstock are converted to low boiling components that can easily be separated in a two phase separation unit (such as a drum) after hydrotreating and cooling. The low boiling components can then be used to generate stream (for production of electricity) in a gas boiler or in a reformer for the production of hydrogen for use in the hydrotreater. The amount of low boiling components produced will be a function of the conversion of the cellulose and hemicellulose to sugars in early processes of the invention.

In some embodiments, in the case of pyrolysis, the majority of the remaining cellulose and hemicellulose is converted into a mixture of water soluble components as opposed to the lignin which is converted into an oil soluble fraction. The lignin derived fraction can then either be exported or hydrotreated as described above. The aqueous fraction can then be either concentrated through a process such as evaporation or boiling, or used as a boiler feed. As in the case above, the amount of aqueous phase components produced is a function of the conversion of the sugars in the biomass. The quality of steam or hydrogen produced on site can therefore directly be influenced through biomass to sugar conversion.

In some embodiments, hydrotreatment of lignin yields compounds in the product oil such as phenols, cyclohexanes, benzenes, naphthalene, phenanthrenes, and other hydrocarbon molecules. In some embodiments, pyrolysis can be used to process the high purity lignin to yield fuel additives and other useful chemicals, such as hydrocarbons. The lignin of the present invention is especially useful for further processing because the lignin of the invention contains low levels of impurities such as ash, carbohydrate, and sulfur. High levels of these impurities can result in inefficient hydrolysis or pyrolysis, and yield undesirable products.

The lignin produced by the present invention overcomes the problems associated with previous methods of producing lignin and can yield substantially pure lignin without the need for harsh chemicals, which can also interfere with subsequent lignin processing.

One particular embodiment of the claimed invention, comprises:
a. steam pretreating a lignocellulosic material;
b. subjecting said pretreated lignocellulosic material to biological conversion to yield one or more soluble products and lignin; and,
c. separating the one or more soluble products from said lignin to yield lignin-enriched solids;
d. treating the lignin enriched solids with a liquid hot water or steam treatment (such as described in U.S. Pat. No. 5,846,787);
e. biologically converting or hydrolyzing the subsequent solids to give a material that is further enriched in lignin;

whereby a substantially pure lignin material with low sulfur content (from 2 to 10 times lower than coal) is produced.

In some embodiments, the substantially pure lignin material that is produced by the process is a fine particle (powder) or dust. In some embodiments, slurrying of this powder or dust in an oil or other heady petroleum residue results in a reduced carbon footprint, high energy fuel that is pumpable.

In some embodiments, addition of the finely divided (powdered lignin) into oil that is derived from biomass pyrolysis can be used as a boiler fuel or diesel engine fuel. In some embodiments, pelletization of the lignin yields a solid fuel that has a low carbon footprint and would supplant coal in coal boilers.

In some embodiments, the lignin powder can be slurried for purposes of further hydro-cracking the slurry to obtain a diesel fuel substitute.

Some embodiments of the present invention are illustrated further below by way of the following non-limiting examples.

### EXAMPLES

### Example 1

### Preparation of High-Purity Lignin Using Exogenous Enzymes

A biomass sample (1a) was prepared from mixed hardwood chips using a continuous pretreatment reactor with post-refining. Residence time in the reactor was 10 minutes and operating temperature was 195° C. The pretreatment used steam only; no acid or base was added to control pH.

The resulting pretreated material had composition (dry solids basis) as follows:

| Sample | % Glucan + Xylan | % Lignin | % Ash |
|---|---|---|---|
| 1a | 63.0 | nd* | nd* |

*No data available.

Following pretreatment the samples were washed to remove soluble solids. 2500 g (wet weight) of sample (50% total solids) was pressed into a 150 mm Buchner funnel containing Whatman Sharkskin filter paper. The sample was washed under vacuum with 3750 mL deionized water at 50° C. Sample was pressed by hand until all liquid was removed and the sample was then air-dried at room temperature back to the original 50% total solids content.

Following washing the samples were hydrolyzed for 120 hours. Each sample was hydrolyzed in an 8 L batch in a Sartorius Biostat-B fermentor at initial total solids loading of 10%. Commercial cellulase (Accelerase 1000—66 mg protein/mL) and xylanase (Multifect—114 mg protein/mL) enzymes were added at a dosage of 100 mg protein/g total solids. Hydrolysis conditions were 50° C. at pH 5.0, and agitation of 500 rpm.

Following hydrolysis, the lignin was recovered. Residual solids were recovered by filtration as described above, and washed with 8 L of deionized water at 50° C. The washed solids were transferred to a 40° C. convection oven and dried for 24 hours. The dried solids were transferred to a 4 L Erlenmeyer flask containing 2 L of 7M guanidine-HCl. The resulting mixture was held on a stir plate for 24 hours at 35° C. Again the solids were recovered by vacuum filtration and washed with an additional 8 L of deionized water at 50° C. The resulting lignin was transferred to a convection oven and dried for 24 hours at 40° C. to yield a dried lignin sample (lb).

Composition (dry solids basis) of the resulting lignin product was as follows:

| Sample | % Glucan + Xylan | % Lignin | % Ash |
|---|---|---|---|
| 1b | 10.2 | 84.6 | 1.25 |

### Example 2

### Preparation of High-Purity Lignin Using Exogenous Enzymes and SSCF

A biomass sample (2a) was prepared from white birch chips using a continuous pretreatment reactor with post-refining. Residence time in the reactor was 10 minutes and operating temperature was 195° C. The pretreatment used steam only; no acid or base was added to control pH.

The resulting pretreated material (2a) had composition (dry solids basis) as follows:

| Sample | % Glucan + Xylan | % Lignin | % Ash |
|---|---|---|---|
| 2a | 59.7 | 13.9 | nd* |

*No data available

Following pretreatment, the sample was washed to remove soluble solids. 800 g (wet weight) of 2a (45% solids) was pressed into a 150 mm Buchner funnel containing Whatman Sharkskin filter paper. The sample was washed under vacuum with 350 ml deionized water at 25° C. Sample was pressed by hand until all liquid was removed and the sample was then air-dried at room temperature overnight.

Following washing the sample was prepared for Simultaneous Saccharification and Co-Fermentation (SSCF). A 2 L Sartorius Biostat-A+ fermentor was initially sterilized empty and the following materials were added:

263 g washed 2a; 50 mL nutrient solution containing 3 g corn steep liquor, 3 g diammonium phosphate, and 1.23 g magnesium sulfate; 293.70 mL deionized water; 30.3 mL cellulase enzyme (Accelerase 1000).

The pH was adjusted to 5.0 with 5M KOH and the mixture was pre-hydrolyzed for 3 hours at 50° C., after which an additional 263 g washed 2a was added and further pre-hydrolyzed for an additional 3 hours. The mixture was cooled to 35° C., and 1 mL penicillin-G solution was added to give 3 mg/L final penicillin-G concentration.

Meanwhile an inoculum for the SSCF was prepared. Strain M0509 is a genetically engineered strain of Saccharomyces cerevisiae which is able to efficiently ferment xylose by: 1) up-regulation of the endogenous yeast pentose phosphate pathway genes TAL1, TKL1, RPE1, and RIM; 2) heterologous expression of xylose isomerase and xylulose kinase; 3) deletion of a non-specific aldose reductase. This strain is taught in WO 2006/009434 A1, which is incorporated herein in its entirety by reference.

Growth medium YPX was prepared using 10 g/L yeast extract, 20 g/L peptone, and 20 g/L xylose, and filter sterilized. 50 mL of YPX was transferred to a sterile 250 mL baffled flask with foam closure. The flask was inoculated with M0509 from an agar plate and placed in an incubator at 30° C. and 250 rpm. After 16 hours, 50 ml additional YPX was added to the flask. After 24 hours total incubation time, 100 mL of inoculum was transferred to the fermentor and SSCF was initiated.

SSCF was conducted at 35° C. with the pH controlled in the range 4.8-5.0. After 120 hours of fermentation, ethanol concentration had reached 39 g/L while glucose and xylose were approximately 1 g/L each

Following fermentation the lignin was recovered. The fermentation broth was first autoclaved at 121° C. for 10 minutes, after which residual solids were recovered by Buchner funnel filtration as described above, and washed with 8 L of deionized water at 50° C. The washed solids were transferred to a 40° C. convection oven and dried for 24 hours.

Composition (dry solids basis) of the resulting lignin product (2b) was as follows:

| Sample | % Glucan + Xylan | % Lignin | % Ash |
|---|---|---|---|
| 2b | 23.9 | 73.4 | 0.34 |

### Example 3

### Production of High-Purity Lignin Using Two Stage Biotreatment

Post fermentation, lignin-rich solids were separated from the liquid fraction after a fermentation reaction. The material was treated with liquid hot water at 30% dry solids loading (300 g dry solids/L liquid) at 200° C. for 10 min (plus 5 min heat-up time). The treatment conditions applied are the optimum pretreatment conditions for poplar hydrolysis. Liquid hot water treatment was carried out using a 1″ OD and 4.5″ length stainless steel tube reactor. The tube containing the slurry was placed in a fluidized sand bath which was set to 200° C. as described in U.S. Pat. No. 5,846,787.

The liquid hot water treated slurry was hydrolyzed at either 5% or 30% dry solids loading. For 5% dry solids hydrolysis pH 4.8 citrate buffer was added to the treated slurry to dilute it to 5% dry solids. Enzyme loading for the secondary hydrolysis was 15 FPU Spezyme CP and 40 IU Novo199 per gram of glucan. Hydrolysis was carried out at 200 rpm, 50° C. for 72 hours. The samples were analyzed by Aminex HPX-87-H column.

Runs made in this study are summarized below. Control runs refer to hydrolysis of the substrate without liquid hot water treatment.

| | | | Dry Solids |
|---|---|---|---|
| | Liquid hot | Washing step | loading for |
| Experiments | water treatment | after treatment | hydrolysis |
| Control1 | No | — | 5% (w/v) |
| Control2 | No | — | 30% (w/v) |
| Experiment1 | Yes, 30% w/v solids | No | 5% w/v |
| | loading, 200 C., 10 min | | |
| | (+5 min heatup) | | |
| Experiment2 | Yes, 30% w/v solids | No | 30% w/v |
| | loading, 200 C., 10 min | | |
| | (+5 min heatup) | | |
| Experiment5 | Yes, 30% w/v solids | Yes (80-90 C. | 30% w/v |
| | loading, 200 C., 10 min | DI water | |
| | (+5 min heatup) | immediately after | |
| | | pretreatment, | |
| | | 500 mL/tube) | |

The table below summarizes the compositions of the substrate, before and after hot water treatment and secondary enzymatic hydrolysis. After secondary enzymatic hydrolysis, xylan was completely removed from the fermentation solids. Glucan content is reduced from 19% to 11% due to the hydrolysis. As a result, lignin is increased from 60% to 75%.

| | | | Fermentation solids | |
|---|---|---|---|---|
| | | | after hot water | |
| | Fermentation | | treatment, washing, and | |
| | solids | | enzymatic hydrolysis | |
| | % dry | Relative | | Relative |
| Component | mass | Deviation | % dry mass | Deviation |
| Glucan | 18.92% | 3.12% | 10.5% | 2.0% |
| Xylan/Galactan | 4.47% | 3.06% | None | |
| Arabinan | None | | None | |
| Acetyl | None | | None | |
| Total Lignin | 58.7% | | 74.9% | |
| Acid Insoluble Residue | 55.47% | 1.07% | 71.0% | 0.6% |
| Ash | 4.18% | 1.58% | 4.5% | 27.1% |
| Mass Balance | 86.24% | | 89.9% | |

### Example 4

### Production and Characterization of High Purity Lignin

Fermentation solids were obtained as described above. Substrate at 30% w/w dry solids was liquid hot water treated at 200° C., 5 min (+5 min heat up time). As the fermentation solids were already at 30% dry solids w/w (70% moisture), no additional water was added. About 3 kg of the liquid hot water treated solids were generated.

The liquid hot water treated slurry was divided into four 1 L Nalgene bottles (˜750 mL solids per bottle) and warm water (˜80° C.) was added to the bottles for washing. The washing step was carried out two times. Each time, about 1.5 L of warm water per bottle was used to wash the pretreated slurry. The washate was removed by filtration using No. 1 filter paper (pore size=11 μm). A 50 mM citrate buffer at pH 4.8 was added to each bottle to bring to total volume to 1 L. The resulting slurry was approximately 15% dry solids by wt per volume of liquid. The material was transferred to 1 L Erlenmeyer flask and 15 FPU Spezyme CP cellulase and 40 CBU Novozym 188 beta-glucosidase per gram of glucan were added for secondary enzymatic hydrolysis. The slurry was incubated at 50° C. at 200 rpm. After 84 hrs, hydrolysate liquid was removed by filtration and the retained solids were washed with warm water. The solids were then spread out on trays to dry at 45° C. for 5 hrs. An aliquot of 10 g of the dried solids were retained from compositional analysis. A total of 150 g of original fermentation solids (moisture=3.8%) and 150 g of enzymatically hydrolyzed fermentation solids (moisture=3.5%) were sent to Consol Energy Inc. (South Park, Pa.) for heating value and sulfur content measurements.

The following table shows the compositions of fermentation solids and purified lignin generated from the fermentation solids after liquid hot water treatment and hydrolysis:

| | | | Fermentation solids | |
|---|---|---|---|---|
| | | | after liquid hot water | |
| | | | pretreatment, washing, | |
| | | | and secondary enzymatic | |
| | Fermentation solids | | hydrolysis | |
| | | Relative | | Relative |
| Component | % dry mass | Deviation | % dry mass | Deviation |
| Glucan | 18.92% | 3.12% | 14.0% | 8.2% |
| Xylan/Galactan | 4.47% | 3.06% | 2.3% | 8.2% |
| Arabinan | None | | None | |
| Acetyl | None | | None | |
| Total Lignin | 58.7% | | 67.4% | |
| Ash | 4.18% | 1.58% | 4.5% | |
| Mass Balance | 86.24% | | 88.2% | |

Due to the removal of glucan and xylan from the fermentation solids by secondary enzymatic hydrolysis, total lignin content of the resulting laboratory generated lignin was increased from 60% to 67%. The conversion of remaining cellulose in the fermentation solids to glucose was approximately 60%, resulting in 18 g/L glucose concentration in the hydrolysate. Total mass balance did not add up to 100% possibly due to other components not measured, such as proteins.

Sulfur content and heating value of fermentation solids and enzymatically hydrolyzed fermentation solids were measured at Consol Energy Inc. (South Park, Pa.). The sulfur content was measured as it is used to calculate an accurate gross calorific value. By definition, the gross calorific value is obtained when the product of sulfur combustion is SO₂. In actual bomb combustion processes, all of the sulfur is found as H₂SO₄. The sulfur content was specifically used to correct for the energy of formation of sulfuric acid. The measurement results are given in the following table:

| | | | Heating value |
|---|---|---|---|
| | Moisture | Sulfur content | (HHV) |
| | (%) | (by dry wt %) | (dry BTU/lb) |
| Fermentation solids | 3.8% | 0.12% (±0.02%) | 9203.7 (±220.0) |
| Lignin (liquid hot | 3.5% | 0.09% (±0.0%) | 9884.0 (±144.8) |
| water treated/ | | | |
| hydrolyzed | | | |
| fermentation solids) | | | |

Sulfur contents and heating values of fermentation solids and lignin generated via liquid hot water treatment and enzymatic hydrolysis are depicted. Numbers in parenthesis are errors in 95% confidence index.

Both fermentation solids and lignin generated via liquid hot water treatment and secondary enzymatic hydrolysis after drying in 45° C. oven contained less than 4% moisture. Sulfur content for both fermentation solids and lignin generated via liquid hot water treatment and subsequent enzymatic hydrolysis was less than 0.2% by dry wt. Lignin prepared by either fermentation alone, or by subsequent liquid hot water treatment and enzymatic hydrolysis contained very low sulfur per Btu compared to coal. In comparison, less than or equal to 0.6 lbs of sulfur per million Btu of coal is considered low-sulfur coal (http://www.eia.doe.gov/cneaf/coal/coal_trans/chap3_{—}1.html (Visited Oct. 14, 2009)). The 0.1% by dry wt sulfur content of the lignin generated by fermentation and subsequent enzymatic hydrolysis is equivalent to 0.09 lbs per million Btu. It is 0.13 lbs per million Btu for the fermentation solids.

Energy density (heating value) of the fermentation solids and lignin generated via liquid hot water treatment and subsequent enzymatic hydrolysis was 9204 and 9884 Btu per lb, respectively. As cellulose which has a lower heating value than lignin is removed from the fermentation solids, the heating value was increased. The heating value of the lignin generated via liquid hot water treatment and subsequent enzymatic hydrolysis was comparable to the heating values of lignin (11324 Btu/lb, 11469 Btu/lb), published previously (Robert Wooley, “Development of an ASPEN PLUS physical property database for biofuels component”, ANREL/TP-425-20685, 1996). Energy density of coal is roughly 10334 Btu/lb and ranges somewhere between 7800-12500 Btu/lb. (Fisher, Juliya (2003). “Energy Density of Coal”. The Physics Factbook. http://hypertextbook.com/facts/2003/JuliyaFisher.shtml). The results suggest that the lignin generated from wood has slightly lower or very similar energy contents as coal.

These examples illustrate possible embodiments of the present invention. While the invention has been particularly shown and described with reference to some embodiments thereof, it will be understood by those skilled in the art that they have been presented by way of example only, and not limitation, and various changes in form and details can be made therein without departing from the spirit and scope of the invention. Thus, the breadth and scope of the present invention should not be limited by any of the above-described exemplary embodiments, but should be defined only in accordance with the following claims and their equivalents.

All documents cited herein, including journal articles or abstracts, published or corresponding U.S. or foreign patent applications, issued or foreign patents, or any other documents, are each entirely incorporated by reference herein, including all data, tables, figures, and text presented in the cited documents.

1. A process for treating a lignocellulosic material, comprising:
(a) steam pretreating a lignocellulosic material
(b) subjecting said pretreated lignocellulosic material to biological conversion to yield one or more soluble products and lignin; and,
(c) separating the one or more soluble products from said lignin to yield substantially pure lignin.

2. The process according to claim 1, wherein said treatment of said lignocellulosic material comprises use of no solvent other than liquid water or steam.

3. The process according to claim 1, wherein said steam pretreatment takes place in a batch.

4. The process according to claim 1, wherein said steam pretreatment takes place in a continuous manner.

5. The process according to claim 1, wherein said steam pretreatment comprises placing the lignocellulosic material in a pressurized chamber.

6. The process according to claim 5, wherein said steam pretreatment comprises pressurized steam-treating said lignocellulosic material at a temperature range of 150-250° C.

7. The process according to claim 5, wherein said steam pretreatment comprises pressurized steam-treating said lignocellulosic material at a temperature range of 180-220° C.

8. The process according to claim 7, wherein said steam pretreatment comprises pressurized steam-treating said lignocellulosic material for between five and fifteen minutes.

9. The process according to claim 1 wherein said steam pretreatment comprises rapid depressurization.

10. The process according to claim 1 wherein said steam pretreatment comprises post-refining to reduce particle size.

11. The process according to claim 1, wherein said steam pretreatment is pH controlled by the addition of a base to maintain pH between about 5 and 8.

12. The process according to claim 1, wherein said biological conversion comprises fermenting said lignocellulosic material.

13. The process according to claim 12, wherein said fermenting comprises fermenting by simultaneous saccharification and co-fermentation.

14. The process according to claim 13, wherein said lignocellulosic material is fermented by an organism selected from the group consisting of Clostridium thermocellum, Thermoanaerobacterium saccharolyticum, Saccharomyces cerevisiae, Kluveromyces marxianus, Escherichia coli, Zymomonas mobilis, Bacillus stearothermophilus, Pichia stipitis, and Escherichia coli.

15. The process according to claim 14, wherein said organism produces one or more cellulases or xylanases.

16. The process according to claim 15, wherein said one or more cellulase is selected from the group consisting of endoglucanases, exoglucanases, β-glucosidases, cellobiohydrolases, endo-xylanases, beta-xylosidases, xylobiohydrolases. exoxylanases, β-xylosidases, arabinoxylanases, mannases, galactases, pectinases, glucuronidases, amylases, α-amylases, β-amylases, glucoamylases, α-glucosidases, and isoamylases.

17. The process according to claim 15, wherein said cellulase or xylanase is tethered to the surface of the cell.

18. The process according to claim 15, wherein said cellulases or xylanases are exogenously added.

19. The process according to claim 1, wherein one or more soluble products are separated from said lignin by a beer stripper.

20. The process according to claim 1, wherein said substantially pure lignin is separated from said one or more soluble products by a filter.

21. The process according to claim 1, wherein said substantially pure lignin is separated from said one or more soluble products by centrifugation.

22. The process according to claim 1, wherein said substantially pure lignin is dried.

23. The process according to claim 22, wherein said substantially pure lignin is dried with heat.

24. The process according to claim 22, wherein said substantially pure lignin is dried with an organic solvent.

25. The process according to claim 22, wherein said substantially pure lignin is dried with ethanol.

26. The process according to claim 1, wherein said substantially pure lignin is at least 50% pure.

27. The process according to claim 1, wherein said substantially pure lignin is at least 70% pure.

28. The process according to claim 1, wherein said substantially pure lignin is at least 80% pure.

29. The process according to claim 1, wherein said substantially pure lignin is at least 90% pure.

30. The process according to claim 1, wherein said substantially pure lignin contains no more than 0.4 percent ash.

31. The process according to claim 1, wherein said substantially pure lignin contains no more than 0.2 percent ash.

32. The process according to claim 1, wherein said substantially pure lignin contains no more than 0.1 percent ash.

33. The process according to claim 1, wherein said substantially pure lignin contains no more than 11 percent carbohydrate.

34. The process according to claim 1, wherein said substantially pure lignin contains no more than 5 percent carbohydrate.

35. The process according to claim 1, wherein said substantially pure lignin contains no more than 2 percent carbohydrate.

36. The process according to claim 1, wherein said substantially pure lignin contains no more than 1 percent sulfur.

37. The process according to claim 1, wherein said substantially pure lignin contains no more than 0.5 percent sulfur.

38. The process according to claim 1, wherein said substantially pure lignin contains no more than 0.25 percent sulfur.

39. The process according to claim 22, wherein the substantially pure lignin is further processed by hydrotreating.

40. The process according to claim 22, wherein the substantially pure lignin is further processed by pyrolysis.

41. The process according to claim 1, wherein the substantially pure lignin is used as feedstock for the production of fuels selected from the group consisting of synthesis gas, liquid fuel, solid fuel, and specialty chemicals.

42. The process according to claim 1, wherein two or more microorganisms are cultured in a series, by growing a primary microorganism, optionally followed by removal of the primary microorganism, and then by growing one or more additional organisms on the substrate.

43. The process according to claim 1, wherein after step (c) the substantially pure lignin is subjected to a second hydrolysis step.

44. The process of claim 1 wherein two or more microorganisms are co-cultured.

45. A lignin product produced by the process of claim 1.
